(19) United States
(12) Patent Application Publication
(10) Pub. No.: US 2025/0357681 A1
(43) Pub. Date: Nov. 20, 2025

(54) CONNECTIVE TERMINAL AND CONNECTOR ASSEMBLY

(71) Applicant: Tyco Electronics (Shanghai) Co., Ltd., Shanghai (CN)

(72) Inventors: Chunjie Hu, Shanghai (CN); Wenfang (Felix) Zhang, Shanghai (CN); Zhimin Zhang, Shanghai (CN); Yongjian (Justin) Huang, Shanghai (CN); Tongbao (Tim) Ding, Shanghai (CN)

(73) Assignee: Tyco Electronics (Shanghai) Co., Ltd., Shanghai (CN)

(21) Appl. No.: 19/210,365

(22) Filed: May 16, 2025

(30) Foreign Application Priority Data
May 17, 2024 (CN) 202410620527.8

(51) Int. Cl. H01R 4/2429; H01R 4/48

(52) U.S. Cl. CPC H01R 4/2429; H01R 4/484; H01R 4/4848

(57) ABSTRACT

A connective terminal for electrical contact with a mating member includes a first side wall and a cantilever-type contact. The cantilever-type contact has a fixed end disposed adjacent to the first side wall, a free end, and a first protrusion disposed on the cantilever-type contact and protruding toward the first side wall. The free end moves toward the first side wall and the first protrusion abuts against the first side wall when the mating member enters the connective terminal and contacts the cantilever-type contact.

### CROSS-REFERENCE TO RELATED APPLICATIONS

This application claims the benefit of the filing date under 35 U.S.C. § 119(a)-(d) of Chinese Patent Application No. 202410620527.8, filed on May 17, 2024.

### FIELD OF THE INVENTION

The present disclosure relates to the field of electrical connectors, and more particularly, to a connective terminal and a connector assembly.

### BACKGROUND OF THE INVENTION

Current connective terminals are used for connecting wires. These connective terminals also need to form stable electrical contact with the mating terminal, and then they are electrically connected to an external circuit through the mating terminal. The connective terminal typically has a box-shaped connection portion and the mating terminal has an insertion end with a shape of a pin or blade. After the insertion end of the mating terminal is inserted into the box-shaped interior of the connective terminal, it is in electrical contact with the connection portion at one or both areas.

However, in the prior art, insufficient physical contact may be formed between the connection portion of the connective terminal and the insertion end of the mating terminal, which will reduce the reliability of the electrical connection. For example, after the entire connector assembly is subjected to a thermosetting plastic material molding process, the connection portion is separated from the insertion end so that a stable electrical connection cannot be formed.

### SUMMARY OF THE INVENTION

A connective terminal for electrical contact with a mating member includes a first side wall and a cantilever-type contact. The cantilever-type contact has a fixed end disposed adjacent to the first side wall, a free end, and a first protrusion disposed on the cantilever-type contact and protruding toward the first side wall. The free end moves toward the first side wall and the first protrusion abuts against the first side wall when the mating member enters the connective terminal and contacts the cantilever-type contact.

### BRIEF DESCRIPTION OF THE DRAWINGS

Features, advantages, and other aspects of embodiments of the present disclosure will become more apparent from the following detailed description with reference to the accompanying drawings. Several embodiments of the present disclosure are shown therein by way of example and not limitation. In the drawings:

FIG. 1 shows a front view of a connective terminal according to an embodiment of the present disclosure;

FIG. 2 shows a side view of a connective terminal according to an embodiment of the present disclosure;

FIG. 3 shows a sectional side view of a connective terminal when it is not in electrical contact with a mating member according to an embodiment of the present disclosure;

FIG. 4 shows a side view of a connective terminal with a mating member inserted according to an embodiment of the present disclosure;

FIG. 5 shows a perspective view of a connector assembly with a housing cover opened according to an embodiment of the present disclosure; and

FIG. 6 shows a perspective view of a connector assembly with a housing cover snapped onto a body according to an embodiment of the present disclosure.

### DETAILED DESCRIPTION

In the following detailed description of the embodiments, reference is made to the accompanying drawings, which form a part of the present disclosure. The accompanying drawings show, by way of illustration, specific embodiments in which the present disclosure can be realized. The exemplary embodiments are not intended to exhaust all embodiments of the present disclosure. In the specification, same or similar reference numerals indicate same or similar components. It should be understood that other embodiments may be utilized and structural modifications may also be made without departing from the scope of the present disclosure. Therefore, the following detailed description is not limiting, and the scope of the present disclosure is defined by the appended claims.

The terms “includes”, “comprises” and the like used in the present disclosure should be interpreted as open-ended terms, i.e., “includes/comprises but is not limited to”, indicating that other elements may also be included. The term “one embodiment” indicates “at least one embodiment”. The term “another embodiment” indicates “at least one additional embodiment”.

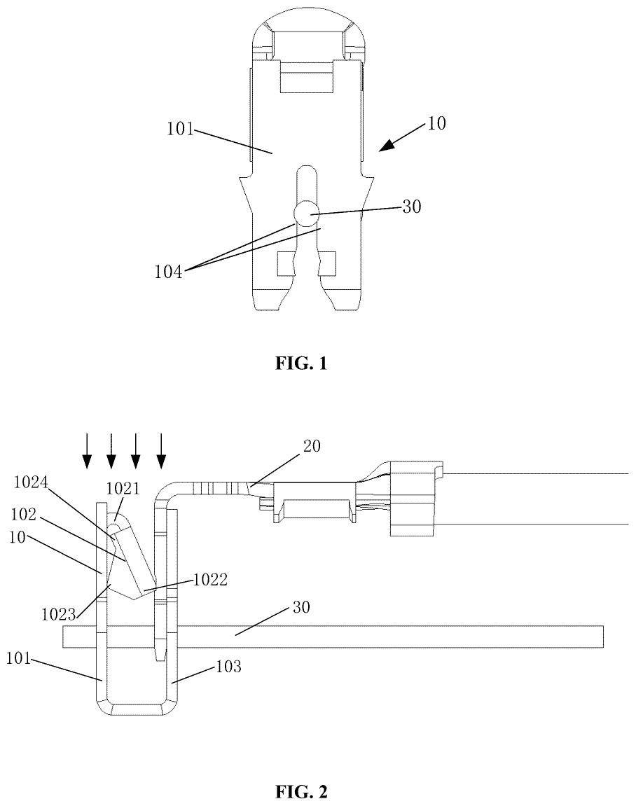

In order to solve the defects of the prior art, the present disclosure first proposes a connective terminal. FIGS. 1 and 2 show front and side views of the connective terminal respectively. As shown in FIG. 2, the connective terminal 10 is configured to be in electrical contact with the mating member 20. The connective terminal includes a first side wall 101 and a cantilever-type contact 102. The cantilever-type contact 102 includes a fixed end 1021, a free end 1022, and a first protrusion 1023. The fixed end 1021 is disposed close, i.e. adjacent, to the first side wall 101. The first protrusion 1023 is disposed on the cantilever-type contact 102 and protrudes towards the first side wall 101.

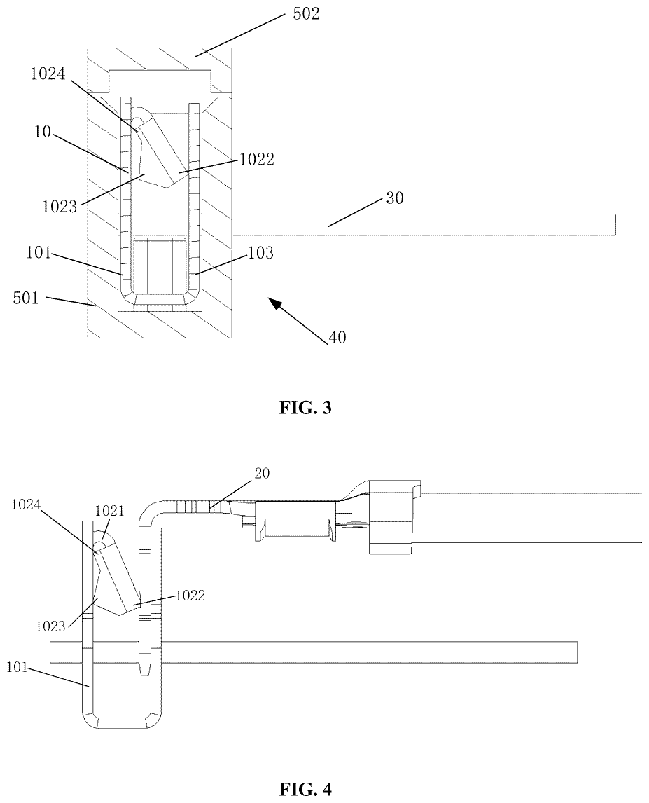

FIG. 3 shows a side view of the connective terminal 10 when it is not in electrical contact with the mating member 20. A small gap is maintained between the first protrusion 1023 and the first side wall 101 of the connective terminal 10. When the mating member 20 enters the connective terminal 10 and contacts with the cantilever-type contact 102, referring to FIG. 2, the free end 1022 moves towards the first side wall 101 and causes the first protrusion 1023 to finally abut against the first side wall 101. When the first protrusion 1023 abuts against the first side wall 101, the contact 102 changes from a structure of a cantilever beam with one free end to a structure of a simple supported beam with support points at both ends. It makes a structural form of the contact 102 in the connective terminal 10 more stable and reliable, and makes the electrical contact with the mating member 20 more stable.

In an example, the connective terminal 10 may be a MAG-MATE terminal, and the mating member 20 may be a TAB terminal having a flat contact. In other examples, the mating member 20 may also be a terminal or a metal connector having other shapes. The mating member 20 can be used to electrically connect with an external circuit or motor.

With continued reference to FIGS. 2 and 3, the connective terminal 10 further includes a second side wall 103 that is disposed opposite to the first side wall 101. When the connective terminal 10 is not in electrical contact with the mating member 20, the free end 1022 of the cantilever-type contact 102 basically contacts or only maintains a small gap with the second side wall 103. When the mating member 20 enters the connective terminal 10, the mating member 20 abuts against the cantilever-type contact 102 and the second side wall 103, which causes the mating member 20 to be in electrical contact with the cantilever-type contact 102 and the second side wall 103, respectively.

In another example, referring to FIG. 3, the cantilever-type contact 102 further includes a second protrusion 1024 that is disposed on the cantilever-type contact 102 and located above the first protrusion 1023. The second protrusion 1024 protrudes towards the first side wall 101. When the connective terminal 10 is not in electrical contact with the mating member 20, a small gap is maintained between the second protrusion 1024 and the first side wall 101. Referring to FIG. 4, when the mating member 20 enters the connective terminal 10 and contacts with the cantilever-type contact 102, the movement of the free end 1022 towards the first side wall 101 also causes the second protrusion 1024 to finally abut against the first side wall 101. The design of the second protruding portion 1024 enables the cantilever-type contact 102 to add a support point against the first side wall 101, and thus the structural form of the contact 102 in the terminal 10 becomes more stable. For example, after undergoing a vibration or thermosetting plastic material molding process, the contact 102 can still maintain a stable electrical contact with the mating member 20.

Referring to FIG. 1, the connective terminal 10 further includes a blade-type open slot 104. It is disposed on the first side wall 101 or the second side wall 103 for piercing a wire 30 and making electrical contact with the wire 30, achieving an electrical connection between the connective terminal 10 and the wire 30.

The present disclosure also provides a connector assembly 40. The connector assembly 40 includes the above connective terminal 10 and the mating member 20 for electrical contact with the connective terminal 10. The connective terminal 10 includes a first side wall 101 and a cantilever-type contact 102. The cantilever-type contact 102 includes a fixed end 1021, a free end 1022, and a first protrusion 1023, as shown in FIGS. 2-4. The fixed end 1021 is disposed adjacent to the first side wall 101. The first protrusion 1023 is disposed on the cantilever-type contact 102 and protrudes towards the first side wall 101. When the mating member 20 enters the connective terminal 10 and contacts with the cantilever-type contact 102, the free end 1022 moves towards the first side wall 101 and causes the first protrusion 1023 to finally abut against the first side wall 101.

Referring to the above description to the connective terminal 10, the connective terminal 10 of the connector assembly 40 further includes a second side wall 103 that is disposed opposite to the first side wall 101. When the mating member 20 enters the connective terminal 10, the mating member 20 abuts against the cantilever-type contact 102 and the second side wall 103. In addition, the cantilever-type contact 102 may further include a second protrusion 1024 that is disposed on the cantilever-type contact 102 and located above the first protrusion 1023. The second protrusion 1024 protrudes towards the first side wall 101. When the mating member 20 enters the connective terminal 10 and contacts with the cantilever-type contact 102, the movement of the free end 1022 towards the first side wall 101 further causes the second protrusion 1024 to finally abut against the first side wall 101.

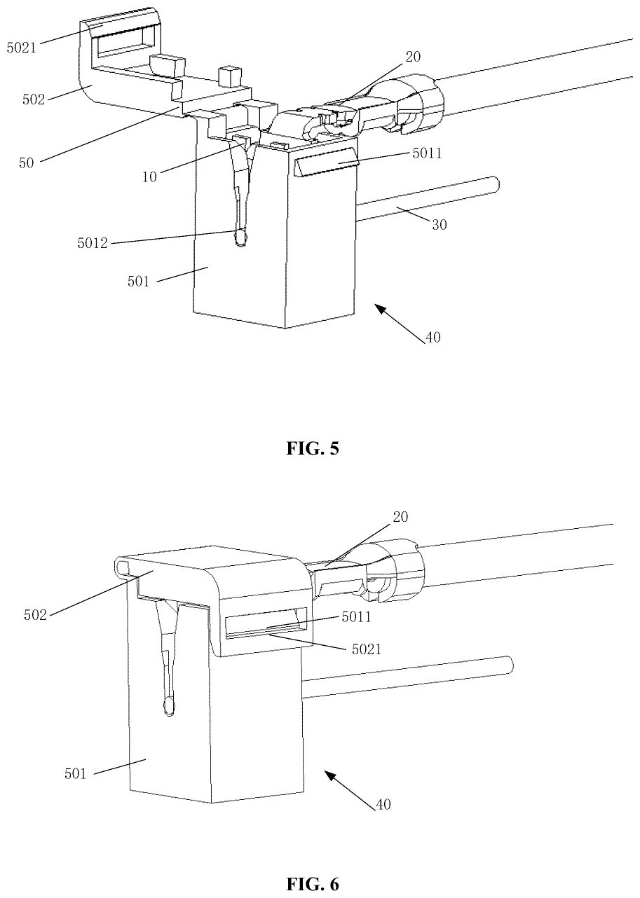

Referring to FIG. 5, the connector assembly 40 further includes a housing 50 that includes a body 501 and a housing cover 502. The body 501 is used for receiving the connective terminal 10. FIG. 6 shows a perspective view of the body 501 with the housing cover 502 fixed above after the mating member 20 enters the connective terminal 10, wherein a contact portion between the connective terminal 10 and the mating member 20 is shielded by and beneath the housing cover 502, thereby protecting the electrical connection of the contact portion. In another example, the housing cover 502 may not shield a non-contact portion between the connective terminal 10 and the mating member 20. In other words, some position of the cover corresponding to the non-contact portion may be hollowed out.

During the thermosetting plastic material molding process, connector assembly 40 may be subjected to material flow in the direction indicated by the arrow in FIG. 2. If the housing cover 502 is not provided for protection, the electrical connection among the mating member 20, the cantilever-type contact 102, and the second side wall 103 will be affected, and even the mating member 20 will be separated from the cantilever-type contact 102 or the second side wall 103.

In one embodiment, the cover 502 is connected and integrally formed with the body 501. Specifically, the housing 50 can be manufactured using one set of molds, which can save manufacturing process of products. Referring to FIGS. 5 and 6, the body 501 of the housing 50 includes a hook member 5011 disposed thereon, and the housing cover 502 includes a latch member 5021 disposed thereon. The latch member 5021 is configured to cooperate with the hook member 5011 to fix the housing cover 502 on the body 501.

In addition, as shown in FIG. 5, the body 501 of the housing 50 further includes a wire slot 5012 disposed inside the body 501, and the wire slot 5012 is used for receiving the wire 30. The connective terminal 10 further includes a blade-type open slot 104 that is disposed on the first side wall 101 for piercing the wire 30 and making electrical contact with the wire 30.

The assembly process of the connector assembly 40 is briefly described below. First, the wire 30 is placed in the wire slot 5012 of the housing 50, and the connective terminal 10 is inserted into the housing 50, such that the blade-type open slot 104 of the connective terminal 10 forms an electrical connection with the wire 30. Subsequently, the mating member 20 is inserted into the connective terminal 10 such that the two are in electrical contact. Finally, the housing cover 502 of the housing 50 is fixed on the body 501 to complete the assembly.

It should be noted that only certain embodiments of the present invention are listed above, and it is apparent that the present disclosure is not limited to the above embodiments, and there are many similar therewith. Those skilled in the art should also realize that all modifications that are derived from or conceived based on the disclosure of the present invention are within the scope of protection of the present invention.

1. A connective terminal for electrical contact with a mating member, comprising:
a first side wall; and
a cantilever-type contact including a fixed end disposed adjacent to the first side wall, a free end, and a first protrusion disposed on the cantilever-type contact and protruding toward the first side wall, the free end moves toward the first side wall and the first protrusion abuts against the first side wall when the mating member enters the connective terminal and contacts the cantilever-type contact.

2. The connective terminal of claim 1, further comprising a second side wall disposed opposite the first side wall.

3. The connective terminal of claim 2, wherein the mating member abuts against the cantilever-type contact and the second side wall when the mating member enters the connective terminal.

4. The connective terminal of claim 1, further comprising a second protrusion disposed on the cantilever-type contact and located above the first protrusion.

5. The connective terminal of claim 4, wherein the second protrusion protrudes toward the first side wall.

6. The connective terminal of claim 5, wherein, when the mating member enters the connective terminal and contacts the cantilever-type contact, a movement of the free end toward the first side wall causes the second protrusion to abut against the first side wall.

7. The connective terminal of claim 3, further comprising a blade-type open slot disposed on the first side wall or the second side wall for piercing a wire and making electrical contact with the wire.

8. A connector assembly, comprising:
a connective terminal including a first side wall and a cantilever-type contact having a fixed end disposed adjacent to the first side wall, a free end, and a first protrusion disposed on the cantilever-type contact and protruding toward the first side wall; and
a mating member inserted into the connective terminal to electrically contact the connective terminal, the free end of the connective terminal moves toward the first side wall and the first protrusion abuts against the first side wall when the mating member enters the connective terminal and contacts the cantilever-type contact.

9. The connector assembly of claim 8, wherein the connective terminal includes a second side wall disposed opposite to the first side wall.

10. The connector assembly of claim 9, wherein the mating member abuts against the cantilever-type contact and the second side wall when the mating member enters the connective terminal.

11. The connector assembly of claim 8, wherein the cantilever-type contact has a second protrusion disposed on the cantilever-type contact and located above the first protrusion.

12. The connector assembly of claim 11, wherein the second protrusion protrudes toward the first side wall.

13. The connector assembly of claim 12, wherein, when the mating member enters the connective terminal and contacts the cantilever-type contact, a movement of the free end toward the first side wall causes the second protrusion to abut against the first side wall.

14. The connector assembly of claim 8, further comprising a housing including a body receiving the connective terminal and a housing cover fixed on the body after the mating member enters the connective terminal.

15. The connector assembly of claim 14, wherein a contact portion between the connective terminal and the mating member is shielded by and beneath the housing cover.

16. The connector assembly of claim 15, wherein the housing cover is connected and integrally formed with the body.

17. The connector assembly of claim 14, wherein the body has a hook member and the housing cover has a latch member cooperating with the hook member to fix the housing cover on the body.

18. The connector assembly of claim 14, wherein the connective terminal has a blade-type open slot disposed on the first side wall for piercing a wire and making electrical contact with the wire.

19. The connector assembly of claim 18, wherein the body has a wire slot receiving the wire.
